(19) United States
(12) Patent Application Publication
(10) Pub. No.: US 2004/0056370 A1
(43) Pub. Date: Mar. 25, 2004

(54) Method for producing a coupling-out surface for the light of an optical fibre

(76) Inventors: Bernard Bachl, Falkensee (DE); Ludwig Plotz, Furth im Wald (DE); Michael Sailer, Pentling (DE); Mario Wanninger, Sunching (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/416,256

(22) PCT Filed: Oct. 26, 2001
(86) PCT No.: PCT/DE01/04073

(30) Foreign Application Priority Data
Nov. 10, 2000 (DE) 100 55 799.6

(51) Int. Cl. B29D 11/00; G02B 6/10

(52) U.S. Cl. 264/1.24; 385/146; 385/31

(57) ABSTRACT

The invention relates to a method for producing a light guide or optical light outcoupling element with a light outcoupling surface which has light outcoupling structures by means of an injection-molding process. The light outcoupling structures are produced by means of laser ablation of the injection mold or of the already injection-molded light guide or light outcoupling element.

The invention relates to a method for producing a light guide or optical light outcoupling element with a light outcoupling surface which has light outcoupling structures by means of an injection-molding process.

In the case of known methods of this type for producing planar light guides or optical light outcoupling elements by means of injection molding, the negative structures of the light outcoupling structures are produced in the area of the injection mold defining the light outcoupling surface by means of lithographic processes together with wet-chemical etching.

A method of this type is not suitable, however, for producing structured three-dimensional light outcoupling surfaces of injection-molded light guides or optical light outcoupling elements, since in these cases lithography is only possible with very great technical expenditure.

The object on which the present invention is based is consequently to develop a method by which light guides or optical light outcoupling elements which have a structured three-dimensional light outcoupling surface can be produced.

This object is achieved by a method with the features of patent claim 1 or 2. A preferred use of light guides or optical light outcoupling elements produced by the method is specified in patent claim 3.

In the case of a first method according to the invention, in particular for producing light guides or optical light outcoupling elements with a structured three-dimensionally curved light outcoupling surface by means of injection molding, firstly the area of the injection mold defining the basic form of the light outcoupling surface is provided with pit- or trench-like depressions by means of a preferably focused laser beam and, after that, the light guide or the optical light outcoupling element is injection-molded.

One particular advantage of the method is that a light guide or optical light outcoupling element can be injection-molded on a test basis by a first structuring procedure and, after that, its outcoupling of light can be measured and, if required, the injection mold can subsequently be provided with additional supplementary and/or corrective structures by means of laser structuring. This test procedure can, if required, be repeated as often as needed until the desired outcoupling of light is optimally reached.

In the case of another method according to the invention for producing a light guide or an optical light outcoupling element with a structured three-dimensionally curved light outcoupling surface by means of injection molding, first the light guide or the optical light outcoupling element is injection-molded and, after that, pit- or trench-like depressions are formed in the three-dimensional light outcoupling surface by means of a preferably focused laser beam.

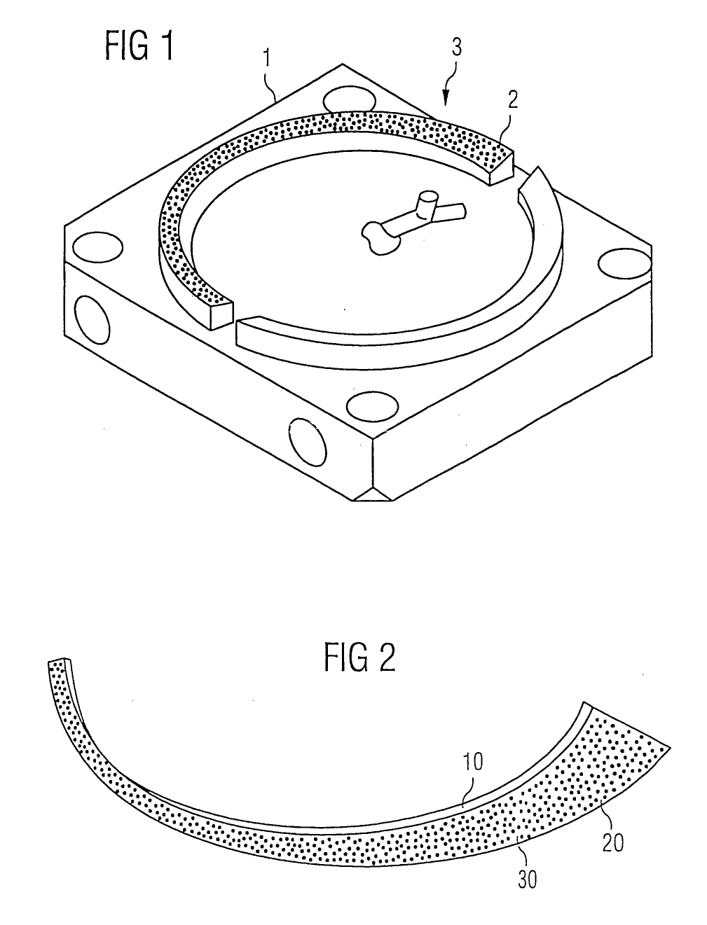

Further advantages and preferred developments are provided by the exemplary embodiments described below in conjunction with FIGS. 1 and 2, in which:

FIG. 1 shows a schematic perspective representation of an injection mold insert and

FIG. 2 shows a schematic perspective representation of a light guide produced by a method according to the invention.

A first exemplary embodiment describes the production of a light guide 10 (cf. FIG. 2), which is intended for optical coupling onto a light-emitting diode arrangement. In the method, point-like depressions 3, which represent the negative structures of the light outcoupling structure and produce small elevations 30 on the light outcoupling surface 20 of the light guide 10, are formed in an area 2, defining a light outcoupling surface 20 of the light guide 10, of an injection mold insert 1 (cf. FIG. 1) for a light guide 10 by means of a focused laser beam. Used for this purpose is a conventional laser device which is known to be suitable for material removal and is not explained in any more detail at this point.

During the processing of the three-dimensionally curved area 2 of the mold insert 1, the latter is preferably on an x-y-z bench, allowing it to be displaced precisely into the desired positions under the laser in all three dimensions. Similarly, however, it is also possible to arrange the laser arrangement displaceably in the x, y and z directions, to allow the laser beam to be variably positioned three-dimensionally as appropriate for the production of the structures.

The particular advantage of this method arises from the good depth of focus which can be achieved with lasers and which is adequate for structuring three-dimensionally curved areas exactly. In comparison with lithography, which in any case is only barely suitable for the structuring of three-dimensionally curved areas, the present method is technically much simpler and technically less complex.

This method can be advantageously carried out repeatedly after a first structuring procedure and the preparation and optical measuring of a test light guide, to improve and/or optimize the light outcoupling surface by adding further point-like depressions. This can be repeated as often as needed until optimum outcoupling of light is achieved.

In the case of both methods, the conventional transparent materials known for the production of light guides or light outcoupling elements, such as plastics, can be used as injection-molding materials.

The method according to the invention can also be readily used for the structuring of planar, that is only two-dimensionally extending, light outcoupling surfaces.

In the case of a method according to the second exemplary embodiment, pit- or trench-like light outcoupling structures are formed in the light outcoupling surface of an injection-molded light guide or light outcoupling element by means of a focused laser beam.

In the case of this method, it is advantageously possible by means of simultaneous irradiation of light and measurement of the radiation characteristic of the light guide by means of the light-emitting diode arrangement to achieve immediate simultaneous optimization of the light outcoupling structure even for different light guide geometries by appropriate adaptation of the laser processing.

The methods according to the invention can also be readily used for the structuring of planar, that is only two-dimensionally extending, light outcoupling surfaces.

1. A method for producing light guides or optical light outcoupling elements with a structured, in particular three-dimensionally curved light outcoupling surface by means of injection molding, with the following method steps:
(a) provision of an injection mold, which defines the basic form of the light guide or the optical light outcoupling element and its light outcoupling surface;
(b) introduction of pit- or trench-like depressions into the light outcoupling surface by means of a laser beam and
(c) injection molding of the light guides or the optical light outcoupling elements.

2. A method for producing a light guide or an optical light outcoupling element with a structured, in particular three-dimensionally curved light outcoupling surface by means of injection molding, with the following method steps:
(a) provision of an injection mold, which defines the basic form of the light guide or the optical light outcoupling element and its light outcoupling surface;
(b) injection molding of the light guide or the optical light outcoupling element and
(c) introduction of pit- or trench-like depressions into the light outcoupling surface of the light guide or the optical light outcoupling element by means of a laser beam.

3. The use of a light guide or optical light outcoupling element produced by a method as claimed in one of the preceding claims in illuminating devices on the basis of luminescent diode components or luminescent diode arrangements.
